(19) United States
(12) Patent Application Publication
(10) Pub. No.: US 2007/0247426 A1
(43) Pub. Date: Oct. 25, 2007

(54) Pointing device for navigating three dimensional space using multiple finger actuated sensors

(76) Inventor: Adrian van der Vorst, Sijhih City (TW)

Correspondence Address: BAYSHORE PATENT GROUP, LLC, 520 CHANTECLER DR., FREMONT, CA, 94539, US

(21) Appl. No.: 11/379,902

(22) Filed: Apr. 24, 2006

(51) Int. Cl. G09G 5/08

(52) U.S. Cl. 345/163

(57) ABSTRACT

The invention relates to the field of pointing devices for navigating in a virtual three-dimensional graphical user interface. The pointing device of the present invention comprises a first sensor and a second sensor, wherein the first sensor is placed at the left button of the pointing device and is operated by the first finger of the user's; wherein the second sensor is placed at the right button of the pointing device and is operated by the second finger of said user's. By engaging in conventional two-finger hand movements that applied in normal mouse operation, the present invention of the pointing device is able to provide a pointing device compatible to various kinds of application software for navigating in a virtual three-dimensional graphical user interface.

### FIELD OF THE INVENTION

The invention relates to the field of pointing devices for computer input, and in particular to a pointing device for navigating in a virtual three-dimensional graphical user interface.

### BACKGROUND OF THE INVENTION

This is a three-dimensional (3D) world. With the soaring of technological development, technology advances in the computer graphics hardware, software and specially, in the computer graphical user interfaces, which will make 3D capabilities available to all mainstream computer systems. Moreover, 3D technology is beginning to be integrated into the Internet technology, making it available to share 3D information across the world. By using the Virtual Reality Modeling Language (VRML), web designers can construct 3D “worlds” in which a remote user can navigate.

The availability of sophisticated applications that present many application tools through the use of graphical icons is one trend in the computer industry. It is common to users that require navigating with a mouse and a keyboard in not only two-dimensions, that is horizontally and vertically, but selecting windows, toolbars and icons presented at many different levels or depth is often required. Those pointing devices available today such as the mouse, the trackball, the joystick, the IBM TrackPoint, the Apple Glide Pad and other available devices provide satisfactory selections in two-dimensional space with both horizontal and vertical direction. However, the selection of a graphic or a window or an icon in a three-dimensional space with a mouse may be cumbersome. Accordingly, a need exists for a pointing device that enables easier navigation of a GUI in not only a two-dimensional space, but to enable easier navigation in a 2-dimensional space with depth, that is a three-dimensional space.

The three-dimensional games present a virtual 3-dimensional environment in which the user must navigate. The joysticks are typically used for these interfaces, but the use of a joystick for general business applications such as a spreadsheets or word processor is often cumbersome. To overcome this, the user is often forced to have two pointing devices, one pointing device for games, such as a joystick, and a separate pointing device, such as a mouse. The use of two pointing devices can be cost expensive, difficult to set up, and adds to desktop clutter.

Several solutions for a pointing device to navigate a three-dimensional interface are disclosed in the prior art. However, several pointing devices engage in unnatural hand movements that require finger and hand movements that oppose normal mouse operation with other three-dimensional or multi-dimensional input controllers. Examples include a multi-button mouse as disclosed in U.S. Pat. Nos. 5,910,798 and 6,198,473, or with a tilt mouse in U.S. Pat. No. 5,367,631, or a mouse with side scroller in U.S. Pat. No. 5,963,197, or a mouse with joystick in U.S. Pat. No. 6,822,638, or a mouse with lever in U.S. Pat. No. 6,480,184. Other pointing devices require more arm and wrist movement than operating a normal computer mouse such as engaging a trackball mounted mouse disclosed in U.S. Pat. No. 5,446,481, or a mouse pod solution disclosed in U.S. Pat. No. 6,611,139, U.S. Pat. No. 6,717,569 and U.S. Pat. No. 6,727,889. Therefore, a need exists for a pointing device to overcome the above limitations.

### SUMMARY OF THE INVENTION

The primary objective of the present invention is to provide a pointing device compatible to various kinds of application software for navigating in a virtual three-dimensional graphical user interface.

The second objective of the present invention is to provide a pointing device compatible to various kinds of application software for navigating in a virtual three-dimensional graphical user interface, wherein pointing device engages in conventional two-finger hand movements that applied in normal mouse operation.

To achieve the purpose of this present invention, the present invention provides a pointing device for navigating in a virtual three-dimensional graphical user interface, which comprises: a first sensor and a second sensor, wherein the first sensor is placed at the left button of the pointing device and is operated by the first finger of the user's; wherein the second sensor is placed at the right button of the pointing device and is operated by the second finger of said user's. The present invention of the pointing device retains normal mouse button and movement operation.

### BRIEF DESCRIPTION OF THE DRAWINGS

Aspects of the present invention are illustrated by way of example, and not by way of limitation, in the accompanying drawings, wherein:

FIG. 1 shows a three-dimensional perspective view of a mouse of the first embodiment of the pointing device for navigating in a virtual three-dimensional graphical user interface.

FIG. 2 shows a three-dimensional perspective view of a mouse of the second embodiment of the pointing device for navigating in a virtual three-dimensional graphical user interface.

FIG. 3 shows a schematic view showing the pointing device of the present invention in one connection state connected to the computer.

FIG. 4 shows a circuit schematic view showing the first sensor of the first embodiment of the present invention.

FIG. 5 is a schematic view showing firmware of the pointing device in FIG. 4 in one operational state.

FIG. 6 shows a circuit schematic view showing the first sensor of the second embodiment of the present invention.

FIG. 7 is a schematic view showing the pointing device in FIG. 6 in one operational state.

FIG. 8 shows a circuit schematic view showing the first sensor of the third embodiment of the present invention.

FIG. 9 is a schematic view showing the firmware of the pointing device in FIG. 8 in one operational state.

FIG. 10 is a schematic view showing the firmware of the pointing device in processing the N state signals in one operation state.

### DETAILED DESCRIPTION OF THE PREFERRED EMBODIMENT

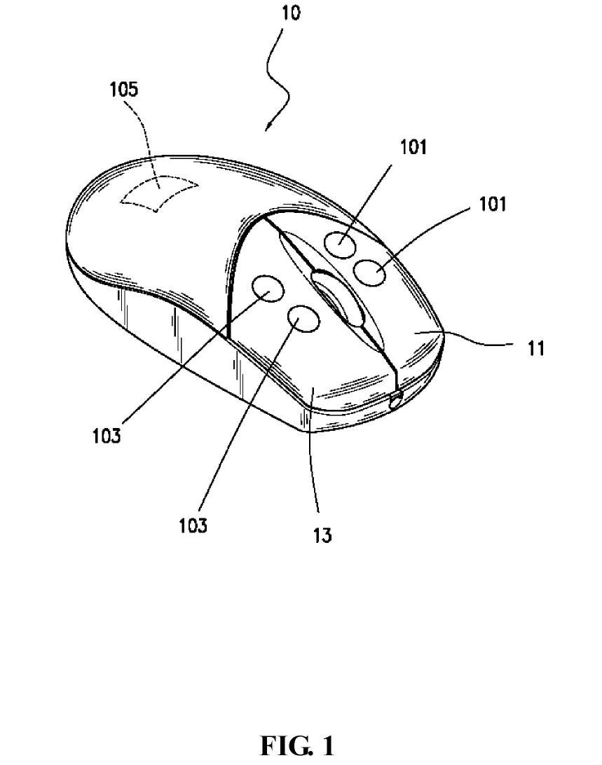

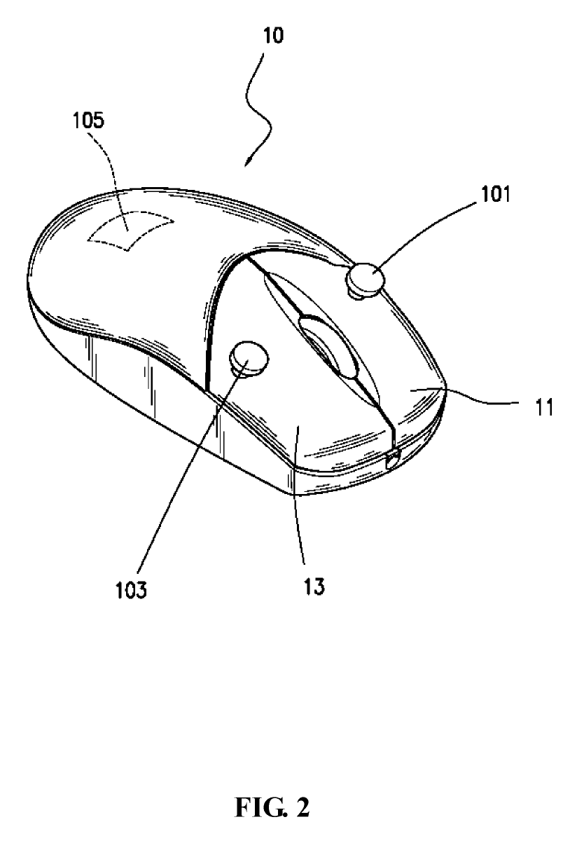

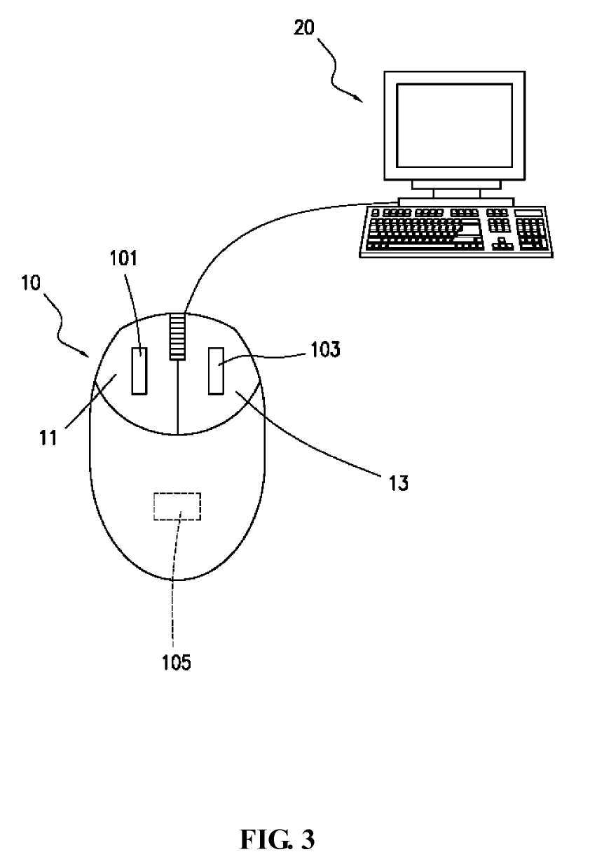

FIG. 1 shows a three-dimensional perspective view of a mouse of the first embodiment of the pointing device for navigating in a virtual three-dimensional graphical user interface. FIG. 2 shows a three-dimensional perspective view of a mouse of the second embodiment of the pointing device for navigating in a virtual three-dimensional graphical user interface. FIG. 3 shows a schematic view showing the pointing device of the present invention in one connection state connected to the computer. The present invention provides a pointing device 10 for navigating in a virtual three-dimensional graphical user interface, which comprises: a first sensor 101 and a second sensor 103, wherein each of the sensors comprises three or more state signals. The pointing device 10 sends out the state signals triggered by the sensors to the computer 20. The computer 20 then actuates and run the drivers exercised by the pointing device 10. Such state signals are then received and processed by the drivers. Therefore, the present invention of the pointing device 10 is capable of providing some software applications including games, CAD, three-dimensional navigation or operations. For example, by calling the drivers, these software applications are able to acquire the current states triggered by the first sensor 101 and the second sensor 103. Such software applications then transform the current states into the corresponding demands for three-dimensional navigation or operations.

As shown in FIG. 1 and FIG. 2, the first sensor 101 is placed at the left button 11 of the pointing device 10 and is operated by the first finger of the user's, wherein the first finger would be the index finger of the right hand. The second sensor 103 is placed at the right button 13 of the pointing device 10 and is operated by the second finger of the user's, wherein the second finger of the user would be the middle finger of the right hand. Therefore, the current invention of the pointing device 10 provides a two-finger dexterity. The sensor operation of the current invention does not interfere with normal mouse operations. Furthermore, by this two-finger operation, users can operate the first sensor 101 and the second sensor 103 as normal mouse button and movement operation by pressing the left button 11 and the right button 13 of the mouse.

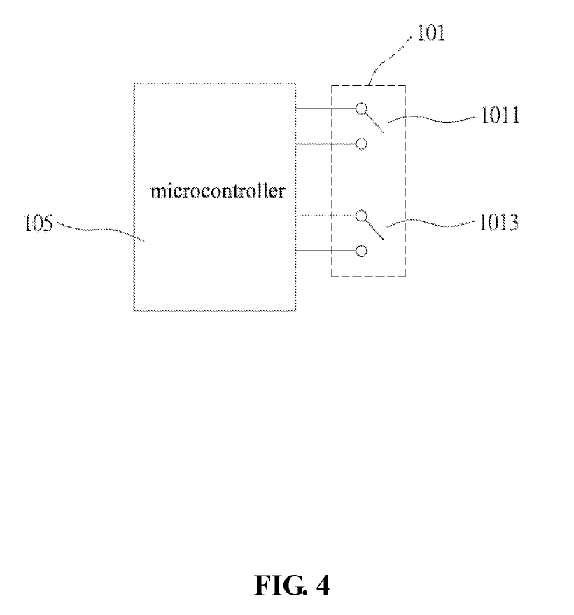

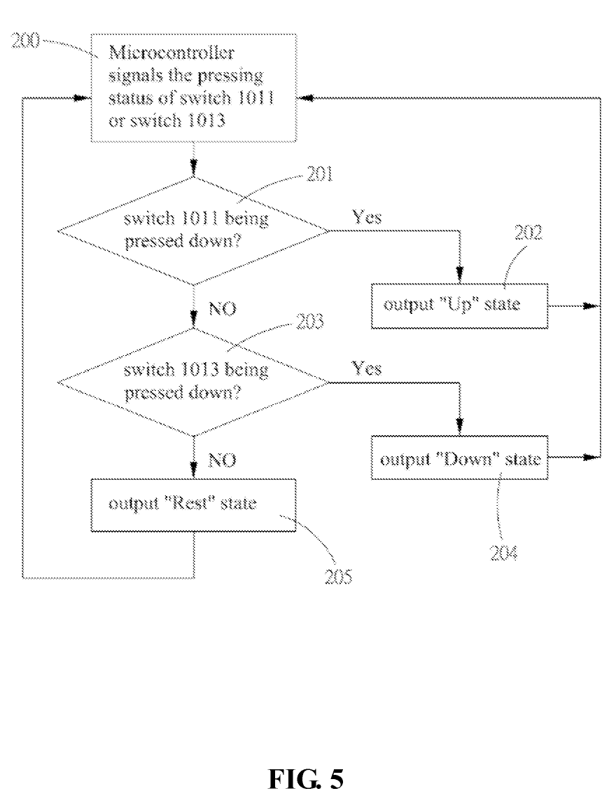

FIG. 4 shows a circuit schematic view showing the first sensor of the first embodiment of the present invention. FIG. 5 is a schematic view showing firmware of the pointing device in FIG. 4 in one operational state. Since the second sensor 103 may be applied by following the similar structure of the first sensor 101, the present invention does not necessarily provide a detailed description for the second sensor 103. In the first embodiment, the first sensor 101 comprises at least one press switch. In step 200, the microcontroller 105 signals the pressing status of the switch 1011 or switch 1013. In step 201, the microcontroller 105 judges whether switch 1011 is being pressed down. If step 201 is true, then it goes to step 202, if not true, then it goes to step 203. In step 202, the microcontroller 105 outputs the first state signal of the first sensor 105, a so-called “Up” state. In step 203, the microcontroller 105 judges whether the switch 1013 is being pressed down. If step 203 is true, then it goes to step 204, if not true, then it goes to step 205. In step 204, the microcontroller 105 outputs the second state of the first sensor 105, a so-called “Down” state. In step 205, the microcontroller 105 outputs the third state of the first sensor 101, a so-called “Rest” state.

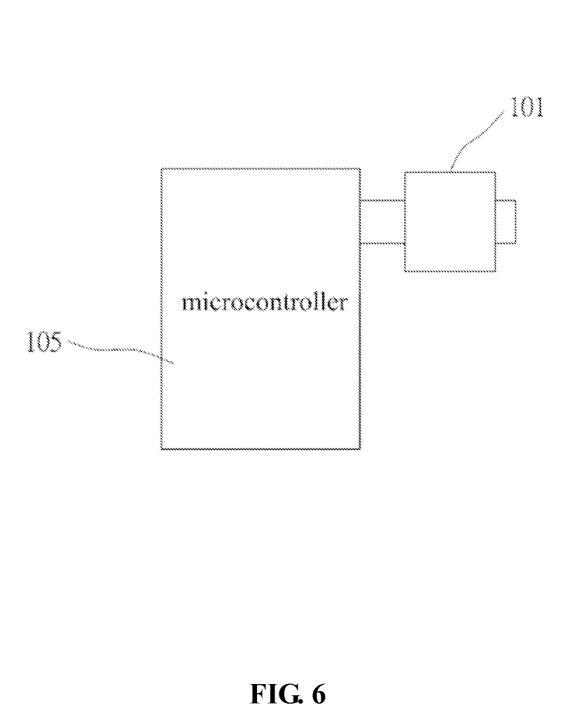

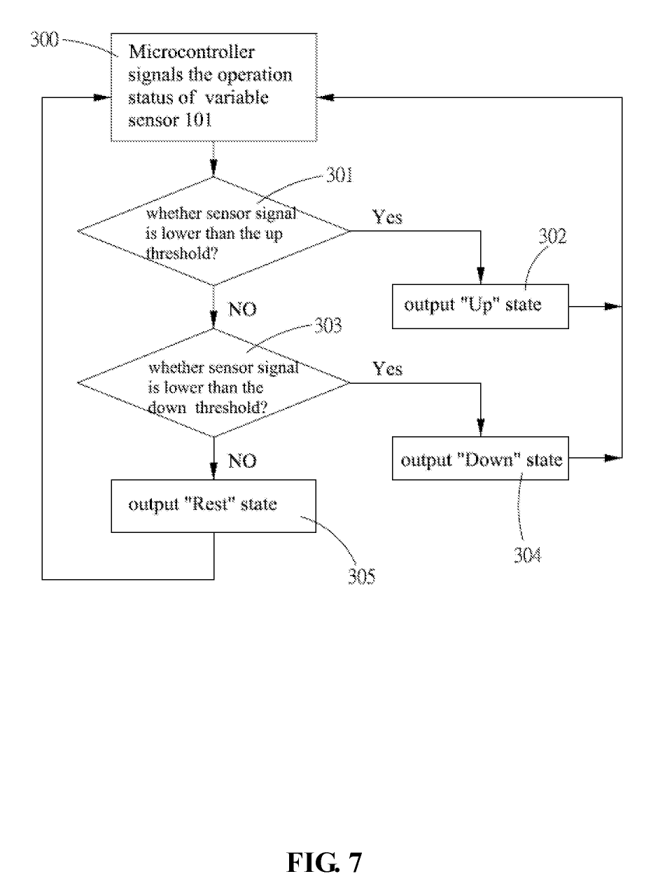

FIG. 6 shows a circuit schematic view showing the first sensor of the second embodiment of the present invention. FIG. 7 is a schematic view showing the pointing device in FIG. 6 in one operational state. Since the second sensor 103 may be applied by following the similar structure of the first sensor 101, the present invention does not necessarily provide a detailed description for the second sensor 103. In the second embodiment, the first sensor 101 comprises a variable sensor, including the VR (variable-resistance) sensor, a proximity sensor, or the pressure sensor. In step 300, the microcontroller 105 signals the operation status of the variable sensor 101. In step 301, the microcontroller 105 judges whether the sensor signal triggered by the variable sensor 101 is lower than the up threshold. If step 301 is true, then it goes to step 302, if not true, then it goes to step 303. In step 302, the microcontroller 105 outputs the first state of the variable sensor 101, a so-called “Up” state. In step 303, the microcontroller 105 judges whether the sensor signal triggered by the variable sensor 101 is lower than down threshold. If step 303 is true, then it goes to step 304. If not, then it goes to step 305. In step 304, the microcontroller outputs a second state signal of the variable sensor 101, a so-called “Down” state. In step 305, the microcontroller outputs a third state of the variable sensor 101, a so-called “Rest” state.

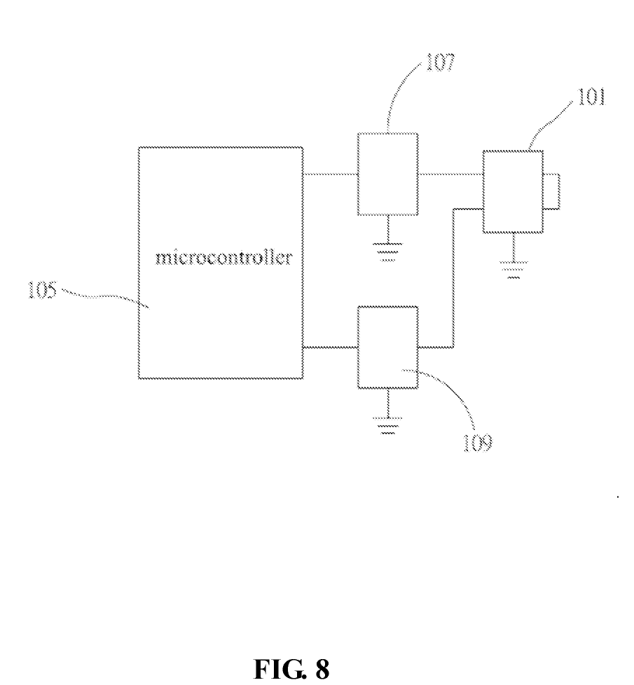

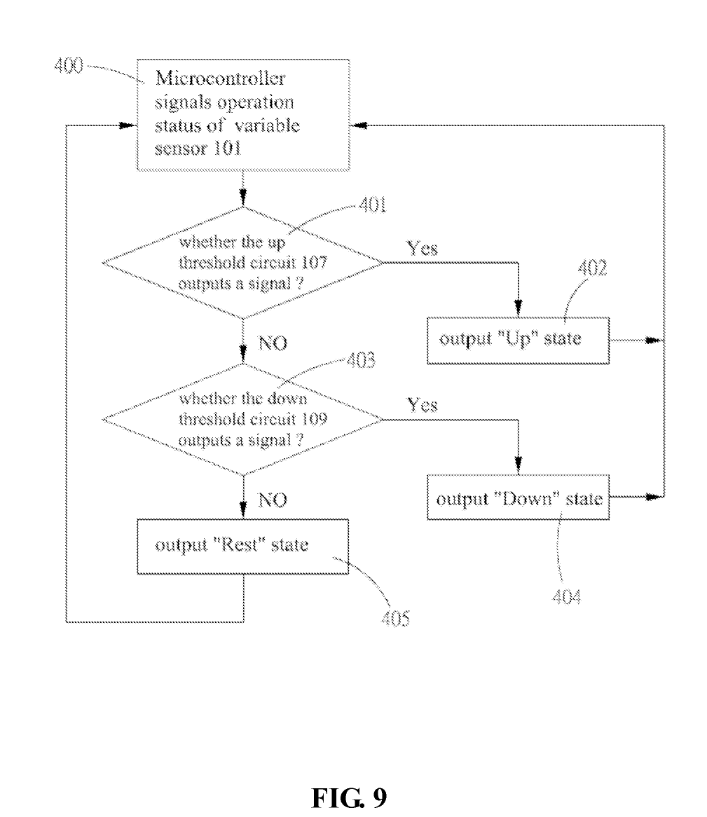

FIG. 8 shows a circuit schematic view showing the first sensor of the third embodiment of the present invention. FIG. 9 is a schematic view showing the firmware of the pointing device in FIG. 8 in one operational state. Since the second sensor 103 may be applied by following the similar structure of the first sensor 101, the present invention does not necessarily provide a detailed description for the second sensor 103. In the third embodiment, the first sensor 101 comprises a variable sensor, including the VR (variable-resistance) sensor, a proximity sensor, or the pressure sensor. The third embodiment adds two more components including the up threshold circuit 107 and the down threshold circuit 109. The up threshold circuit 107 is applied to compare the values of the sensor signal triggered by the variable sensor 101. When the value of the sensor signal is larger than the up threshold, the up threshold circuit 107 then outputs a signal. The down threshold circuit 109 is applied to compare the values of the sensor signal triggered by the variable sensor 101. When the value of the sensor signal is lower than the down threshold, then down threshold circuit 109 then outputs a signal. In step 400, the microcontroller 105 signals the operation status of the variable sensor 101. In step 401, the microcontroller 105 judges whether the up threshold circuit 107 outputs a signal. If step 401 is true, then it goes to step 402, if not true, then it goes to step 403. In step 402, the microcontroller 105 outputs the first state signal of the variable sensor 101, a so-called “Up” state. In step 403, the microcontroller 105 judges whether the down threshold circuit 109 outputs a signal. If step 403 is true, then it goes to step 404. If not, then it goes to step 405. In step 304, the microcontroller outputs a second state signal of the variable sensor 101, a so-called “Down” state. In step 305, the microcontroller outputs a third state signal of the variable sensor 101, a so-called “Rest” state.

According to the detailed descriptions of the first, second and the third embodiments of the present invention, there are many other components that can be applied to the first sensor 101 and second sensor 103. Such components include: mechanical switch, slide switch, touch sensor, and the joystick. Moreover, the components of the first sensor 101 and second sensor 103 can function a so-called self-centering mechanism when the sensors are in the rest state.

Several operational examples can be illustrated to show how the pointing device 10 of the present invention can be applied to the bulldozer operations. We assume that such application programs can be manipulated by the three-dimensional navigation system by the function keys including: ┌W┘ key, ┌A┘ key, ┌Q┘ key, ┌D┘ key, ┌E┘ key, and ┌S┘ key. The following table illustrates the pointing device 10 of the present invention corresponding to these function keys.

| | | | Game |
|---|---|---|---|
| | | | Equivalent |
| Navigation Sensor | | | Keyboard |
| Direction | First Sensor | Second Sensor | Command |
| Rest | Rest State | Rest State | N/A |
| Forward | Up State | Up State | [symbol] W [symbol] key |
| Left | Rest State | Up State | [symbol] A [symbol] key |
| Full Left | Down State | Rest State | [symbol] Q [symbol] key |
| Right | Up State | Rest State | [symbol] D [symbol] key |
| Full Right | Up State | Down State | [symbol] E [symbol] key |
| Back | Down State | Down State | [symbol] S [symbol] key |

The perfect embodiment of the pointing device 10 of the present invention can be a mouse. In addition to the normal mouse operations, by operating the first sensor 101 and second sensor 103, the mouse 10 can provide the necessary tasks for three-dimensional navigation or operations.

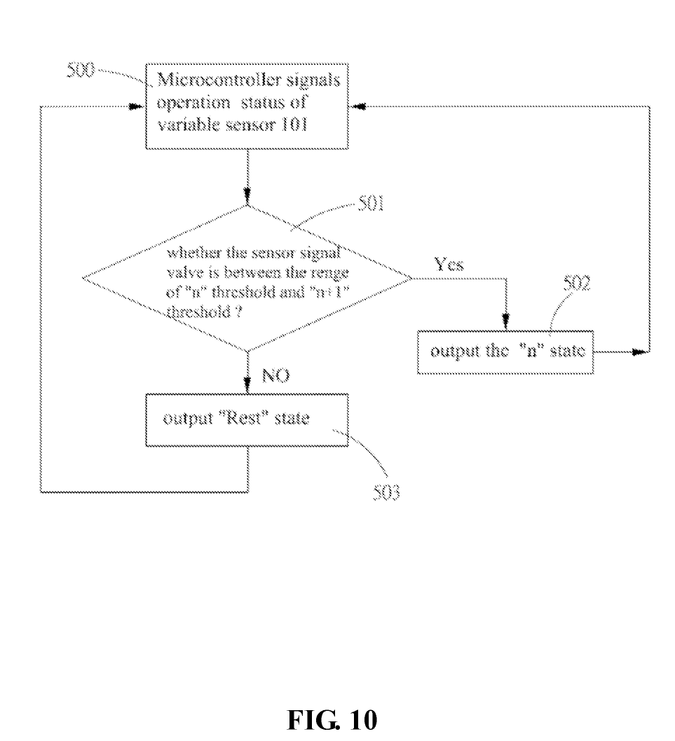

FIG. 10 is a schematic view showing the firmware of the pointing device in processing the N state signals in one operation state. In FIG. 10, the firmware of the first sensor 101 and second sensor 103 is the variable sensor. In step 500, the microcontroller 105 signals the operation status of the variable sensor 101. In step 501, the microcontroller 105 judges whether the sensor signal value triggered by the variable sensor 101 is between the range of “n” threshold and the “n+1” threshold, wherein n>=1, n<=N, and N>=3. If step 501 is true, then it goes to step 502, if not true, then it goes to step 503. In step 502, the microcontroller 105 outputs the first state signal of the variable sensor 101, a so-called “Up” state. In step 502, the microcontroller 105 outputs the n state signal of the variable sensor 101. In step 503, the microcontroller 105 outputs the last state signal of the variable sensor 101, a so-called “Rest” state. Such “Rest” state means that the first sensor 101 and second sensor 103 are not in use and no signals are triggered by the sensors thereof. If N=10, it means that each of the first sensor 101 and second sensor 103 can trigger ten state signals.

Although the present invention has been illustrated and described with reference to the preferred embodiment thereof, it should be understood that it is in no way limited to the details of such embodiment but is capable of numerous modifications within the scope of the appended claims.

1. A pointing device for navigating in a virtual three-dimensional graphical user interface, comprising:
a first sensor, wherein said first sensor is placed at the left button of said pointing device and is operated by the first finger of the user; and
a second sensor, wherein said second sensor is placed at the right button of said pointing device and is operated by the second finger of said user.

2. The pointing device as in claim 1, wherein said first sensor has at least three state signals after operated by said first finger of said user, and said second sensor has at least three state signals after operated by said second finger of said user.

3. The pointing device as in claim 2, wherein said state signals by said first sensor comprises:
an Up signal,
a Rest signal, and
a Down signal.

4. The pointing device as in claim 2, wherein said state signals by said second sensor comprises: an Up state, a Rest state, and a Down state.

5. The pointing device as in claim 2, wherein said first sensor comprises a mechanical switch, a slide switch, a touch sensor, a joystick, a variable sensor.

6. The pointing device as in claim 5, wherein said variable sensor comprises a variable-resistance sensor, a proximity sensor, or a pressure sensor.

7. The pointing device as in claim 2, wherein said second sensor comprises a mechanical switch, a slide switch, a touch sensor, a joystick, a variable sensor.

8. The pointing device as in claim 7, wherein said variable sensor comprises a variable-resistance sensor, a proximity sensor, or a pressure sensor.

9. The pointing device as in claim 1, wherein said first sensor and said second sensor contain self-centering mechanism when said sensors are in the rest state.

10. The pointing device as in claim 1, wherein said pointing device is a mouse.
